(19) United States
(12) Patent Application Publication
(10) Pub. No.: US 2006/0057352 A1
(43) Pub. Date: Mar. 16, 2006

(54) Metal-oxide composite material and method of producing the same

(75) Inventors: Kouichi Ichiki, Chiisagata-gun (JP); Masashi Okubo, Chiisagata-gun (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/076,869

(22) Filed: Mar. 11, 2005

(30) Foreign Application Priority Data
Mar. 15, 2004 (JP) 2004-73154
Feb. 23, 2005 (JP) 2005-047509

(51) Int. Cl. C08K 9/02; B32B 15/14

(52) U.S. Cl. 428/293.1; 428/323; 523/204; 523/206; 525/439; 525/444

(57) ABSTRACT

The method is capable of easily producing a metal-oxide composite material formed into particles, in which fine carbon fibers are uniformly dispersed. The method of producing the metal-oxide composite material comprises the steps of: dispersing fine carbon fibers in an organic solvent including hydrolyzable metallic compound; performing hydrolysis; and performing polycondensation so as to form particles of the metal oxide, whereby the fine carbon fibers are incorporated into particles of the metal oxide.

### BACKGROUND OF THE INVENTION

The present invention relates to a metal-oxide composite material, which are used for powder metallurgical materials, batteries, fillers, etc., and a method of producing the composite material.

These days, particles of metallic composite materials, in which fine carbon fibers, e.g., carbon nano tube (CNT), carbon nano fiber (CNF), are dispersed, have been developed.

On the other hand, metal oxides have been used as materials of powder metallurgical materials, batteries, fillers, etc., but the composite materials formed into particles, in which fine carbon fibers are dispersed, have been never produced. If such composite materials are realized, they can be used in many industrial fields as metal oxides having functions of fine carbon fibers.

To disperse fine carbon fibers in particles of metal oxide particles, the inventors tried to mix the fine carbon fibers with a metal oxide and bake the mixture. However, the fine carbon fibers are apt to agglutinate, and they are finer than the metal oxide. Therefore, it is very difficult to produce the metal-oxide composite material formed into particles, in which the fine carbon fibers were uniformly dispersed.

### SUMMARY OF THE INVENTION

An object of the present invention is to provide a metal-oxide composite material formed into particles, in which fine carbon fibers are uniformly dispersed.

Another object is to provide a method of easily producing the composite material of the present invention.

Firstly, the method of producing the metal-oxide composite material comprises the steps of:
dispersing fine carbon fibers in an organic solvent including hydrolyzable metallic compound;
performing hydrolysis; and
performing polycondensation so as to form particles of the metal oxide, whereby the fine carbon fibers are incorporated into particles of the metal oxide.

In the method, sizes of the particles of the composite material may be controlled by adjusting time of said step of performing the hydrolysis and the polycondensation.

The method may further comprise the steps of:
drying the particles of the composite material; and
breaking the dried particles.

In another case, the method may further comprising the step of baking the particles of the composite material.

In the method, hydroxypropylcellulose may be used as a dispersing agent for dispersing the fine carbon fibers in the organic solvent.

In the method, metal alkoxide may be used as the hydrolyzable metallic compound.

In the method, a catalyst for accelerating the hydrolysis may be used so as to increase hydrolysis rate of the metal alkoxide, and the hydrolysis of the metal alkoxide may be completed within one hour so as to uniformly incorporate the fine carbon fibers into the particles of the metal oxide.

Further, The metal-oxide composite material of the present invention comprises particles of the metal oxide, in which fine carbon fibers are incorporated.

By employing the method of the present invention, the fine carbon fibers can be easily incorporated into the particles of the metal oxide. And, the fine carbon fibers can be uniformly dispersed in the particles, so that characteristics of the composite material can be evened out. Therefore, the composite material having good quality can be easily produced.

### BRIEF DESCRIPTION OF THE DRAWINGS

Embodiments of the present invention will now be described by way of examples and with reference to the accompanying drawings, in which:

FIG. 1 is an electron micrograph of a metal-oxide composite material of EXAMPLE 1;

FIG. 2 is an enlarged view of the electron micrograph shown in FIG. 1;

FIG. 3 is an electron micrograph of a metal-oxide composite material of EXAMPLE 2;

FIG. 4 is an enlarged view of the electron micrograph shown in FIG. 3; and

FIG. 5 is an electron micrograph of a metal-oxide composite material of EXAMPLE 3, in which the composite material has been broken.

### DETAILED DESCRIPTION OF THE EMBODIMENTS

Preferred embodiments of the present invention will now be described in detail with reference to the accompanying drawings.

Conventionally, particles of a metal oxide are produced by a sol-gel process. In the sol-gel process, particles of a metal oxide are produced by the steps of: heating the polycondensed metallic compound; hydrolyzing a hydrolyzable metallic compound in a solvent; and polycondensing the hydrolyzed metallic compound. For example, the hydrolyzable metallic compound is dissolved in an organic solvent, and a catalyst, water, etc. are added to the solvent so as to perform hydrolysis reaction and polycondensation reaction, so that the metal oxide transforms from sol to gel. Further, the gel is dehydrated and formed into powders.

The method of the present invention is based on the sol-gel process. The unique feature of the present invention is to use an organic solvent, in which fine carbon fibers have been dispersed, so that a metal-oxide composite material formed into particles, in which fine carbon fibers are uniformly dispersed, can be produced. For example, a hydrolyzable metallic compound, fine carbon fibers, a catalyst, water and a dispersing agent, if required, are dissolved in an organic solvent, then hydrolysis reaction and polycondensation reaction are performed in the solvent, so that a metal-oxide composite material can be produced.

Note that, in the present invention, the word “metal” includes: general metals defined in the periodic table of the elements; elements of transition metals, lanthanoid and actinoid; and boron and silicon included in nonmetals.

Further, the fine carbon fibers includes carbon nano tubes (CNTs) and non-hollow carbon nano fibers (CNFs).

The hydrolyzable metallic compound may be selected on the basis of an object metal, easiness of a production method, a application of the composite material, etc. Note that, metal alkoxide is suitable for the present invention.

The fine carbon fibers may be dispersed in the organic solvent before or after mixing the hydrolyzable metallic compound into the solvent. Preferably, the fine carbon fibers are previously dispersed in the solvent, then the hydrolyzable metallic compound is added in the solvent, so that the process can be easily performed.

By performing the sol-gel process, the fine carbon fibers are incorporated into particles of the metal oxide, so that the particles of the composite material, in which fine carbon fibers are uniformly dispersed, can be easily produced.

Further, a dispersing agent may be used to suitably disperse the fine carbon fibers in the organic solvent. The preferable dispersing agent is hydroxypropylcellulose.

In the sol-gel process for producing the metal-oxide composite material, particle sizes of the metal-oxide composite material and content of the fine carbon fibers can be controlled by adjusting blending quantities of the fine carbon fibers and the hydrolyzable metallic compound, a sort of the hydrolyzable metallic compound, reaction time, temperature, etc. Therefore, the desired metal-oxide composite material can be easily produced.

By rapidly performing the hydrolysis to complete the hydrolysis in a short time, the fine carbon fibers can be uniformly incorporated into the particles of the metal-oxide composite material. If it takes a long time to perform the hydrolysis, aggregated blocks of the fine carbon fibers, on which minute quantities of the metal oxides are stuck and which deposit in the solvent, and the particles of the metal oxide, which include no fine carbon fibers, are produced.

If the hydrolysis is slowly and calmly performed, relatively big metal-oxide composite materials are apt to be produced. In the present invention, however, by rapidly reacting and completing the hydrolysis in a short time, fine and uniform particles of the metal-oxide composite material can be produced.

To accelerate the hydrolysis, a hydrolyzable metallic compound having high hydrolysis rate and a catalyst for rapidly accelerating the hydrolysis may be used. Further, temperature of the solvent may be risen rapidly. The preferable hydrolyzable metallic compound having high hydrolysis rate is, for example, tetraethyl orthosilicate, which is a metal alkoxide. On the other hand, the preferable catalyst for accelerating the hydrolysis is, for example, ammonia water. The preferable time period of the hydrolysis is one hour or less. For example, the solvent is put into an oven, whose temperature is set at the hydrolysis temperature, heated therein within one hour and taken out therefrom.

When the hydrolyzable metallic compound, the fine carbon fibers, the catalyst, water and the dispersing agent (if required) are mixed into the organic solvent and the solvent is hydrolyzed and polycondensed, the solvent is formed into sol, then formed into gel of the metal-oxide composite material. Preferably, the gel of the composite material is dried to form into dried gel. Further, the dried gel may be broken.

In another case, the dried gel, which is in a state of a hydrate, may be baked to produced baked powders of the metal-oxide composite material. In this case, the composite material can be used in specific fields, in which hydrates cannot be used. Therefore, fields of applying the composite material can be expanded.

In the case of using silicon dioxide as the particles of the metallic oxide, baking temperature should be 1200° C. or less, preferably 400-1100° C., further preferably 800-1100° C. Preferable baking time is about two hours. Further, the bake should be perform in an inert gas atmosphere, e.g., nitrogen gas, argon gas, so as not to burn the fine carbon fibers.

Further, the gel or the dried gel in the state of hydrate may be shaped into a desired shape and baked. In this case, the producing process can be simplified and produced the baked metal-oxide composite material. When the gel is shaped, binders may be mixed with the gel or the dried gel if required.

Successively, examples of experiments will be described.

### EXAMPLE 1

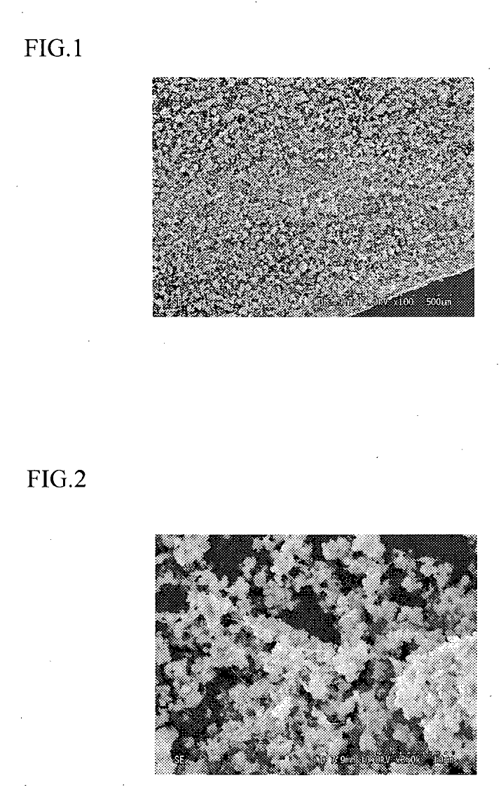

CNTs were dispersed in ethanol with hydroxypropylcellulose, which was used as the dispersing agent. Tetraethyl orthosilicate, which was used as the metal alkoxide, and ammonia water were added to the solvent, in which the CNTs had been dispersed. The ammonia water was used as a catalyst. The solvent was reacted at temperature of 80° C. for 30 minutes, then it was dried to form a metal-oxide composite material into dried gel. In the metal-oxide composite material, the CNTs were incorporated in the metal-oxide particles of silicon dioxide. Electron micrographs of the metal-oxide particles are shown in FIGS. 1 and 2. According to FIG. 1, particle sizes of the particles of the metal-oxide composite material were from several μm to about 50 μm. Further, according to FIG. 2, the CNTs were uniformly dispersed in the particles of the metal-oxide composite material, and they projected from surfaces of the particles.

Further, the dried gel was baked, so that powders of the metal-oxide composite material could be produced.

### EXAMPLE 2

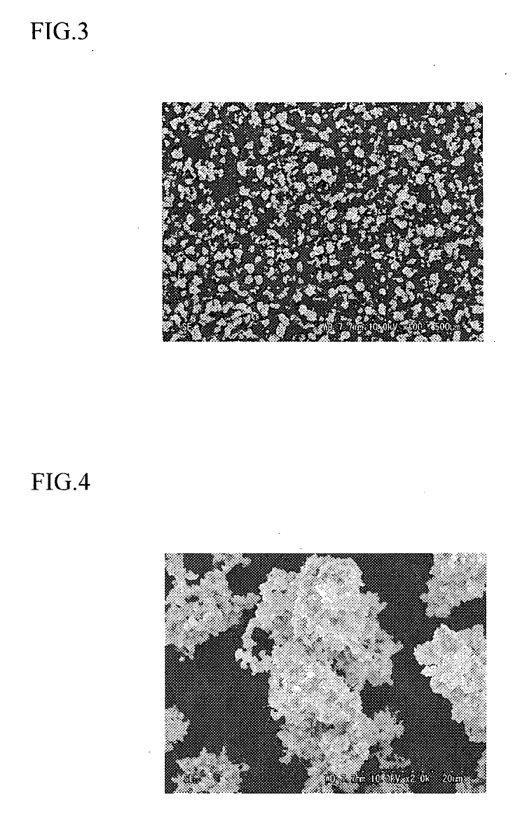

An experiment of EXAMPLE 2 was performed with the same materials and the same process. The solvent was reacted at temperature of 80° C. for 90 minutes, then it was dried to form a metal-oxide composite material into dried gel. Electron micrographs of the dried gel are shown in FIGS. 3 and 4.

In FIG. 3, particle sizes of the particles of the metal-oxide composite material were from several μm to about 100 μm. Therefore, according to results of EXAMPLES 1 and 2, the particle sizes can be controlled by adjusting the reaction time.

Further, according to FIG. 4, the CNTs were uniformly dispersed in the particles of the metal-oxide composite material without reference to the reaction time, and they projected from surfaces of the particles.

The dried gel was baked, so that powders of the metal-oxide composite material could be produced.

### EXAMPLE 3

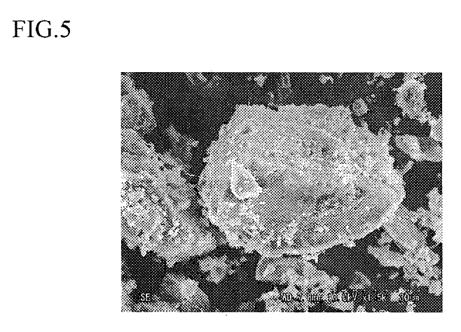

CNTs were dispersed in ethanol with hydroxypropylcellulose, which was used as the dispersing agent. Tetraethyl orthosilicate, which was used as the metal alkoxide, and ammonia water were added to the solvent, in which the CNTs had been dispersed. The solvent was reacted at temperature of 80° C. for 24 hours, then it was dried to form a metal-oxide composite material into dried gel. Particle sizes of the particles of the metal-oxide gel were about 5 mm, and the particles were formed into bulks, which had plate-shapes or tube-shapes and whose sizes were from several mm to several cm. The bulks were broken. An electron micrograph of the broken metal-oxide composite material is shown in FIG. 5. According to FIG. 5, the CNTs were incorporated and uniformly dispersed in the metal-oxide composite material, and they projected from surfaces of the particles of the metal-oxide composite material.

The broken metal-oxide composite material may be further baked so as to form into powders.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of producing a metal-oxide composite material, comprising:
dispersing fine carbon fibers in an organic solvent;
adding a hydrolyzable metallic compound in the organic solvent; and
performing a hydrolysis and polycondensation reaction so as to form particles of the metal oxide,
whereby the fine carbon fibers are incorporated and uniformly dispersed into particles of the metal oxide.

2. The method according to claim 1,
wherein sizes of the particles of the composite material are controlled by adjusting a time of the hydrolysis and the polycondensation reaction.

3. The method according to claim 1, further comprising:
drying the particles of the metal oxide; and
breaking the dried particles.

4. The method according to claim 1, further comprising:
baking the particles of the metal oxide.

5. The method according to claim 1,
wherein hydroxypropylcellulose is used as a dispersing agent for dispersing the fine carbon fibers in the organic solvent.

6. The method according to claim 2,
wherein hydroxypropylcellulose is used as a dispersing agent for dispersing the fine carbon fibers in the organic solvent.

7. The method according to claim 3,
wherein hydroxypropylcellulose is used as a dispersing agent for dispersing the fine carbon fibers in the organic solvent.

8. The method according to claim 4,
wherein hydroxypropylcellulose is used as a dispersing agent for dispersing the fine carbon fibers in the organic solvent.

9. The method according to claim 1,
wherein metal alkoxide is used as the hydrolyzable metallic compound.

10. The method according to claim 2,
wherein metal alkoxide is used as the hydrolyzable metallic compound.

11. The method according to claim 3,
wherein metal alkoxide is used as the hydrolyzable metallic compound.

12. The method according to claim 4,
wherein metal alkoxide is used as the hydrolyzable metallic compound.

13. The method according to claim 5,
wherein metal alkoxide is used as the hydrolyzable metallic compound.

14. The method according to claim 6,
wherein metal alkoxide is used as the hydrolyzable metallic compound.

15. The method according to claim 7,
wherein metal alkoxide is used as the hydrolyzable metallic compound.

16. The method according to claim 8,
wherein metal alkoxide is used as the hydrolyzable metallic compound.

17. A metal-oxide composite material, comprising:
particles of metal oxide having fine carbon fibers incorporated and uniformly dispersed therein.

18. The method according to claim 9,
wherein a catalyst for accelerating the hydrolysis is used so as to increase a hydrolysis rate of the metal alkoxide, and
the hydrolysis of the metal alkoxide is completed within one hour so as to uniformly incorporate and disperse the fine carbon fibers into the particles of the metal oxide.

19. The method according to claim 13,
wherein a catalyst for accelerating the hydrolysis is used so as to increase a hydrolysis rate of the metal alkoxide, and
the hydrolysis of the metal alkoxide is completed within one hour so as to uniformly incorporate and disperse the fine carbon fibers into the particles of the metal oxide.

20. The method according to claim 16,
wherein a catalyst for accelerating the hydrolysis is used so as to increase hydrolysis rate of the metal alkoxide, and
the hydrolysis of the metal alkoxide is completed within one hour so as to uniformly incorporate and disperse the fine carbon fibers into the particles of the metal oxide.
